(19) United States
(12) Patent Application Publication
(10) Pub. No.: US 2004/0224570 A1
(43) Pub. Date: Nov. 11, 2004

(54) Connecting terminal for electrode contact

(76) Inventor: Sheng-Hsing Yeh, Shijr City (TW)

Correspondence Address: TROXELL LAW OFFICE PLLC, SUITE 1404, 5205 LEESBURG PIKE, FALLS CHURCH, VA, 22041, US

(21) Appl. No.: 10/623,535

(22) Filed: Jul. 22, 2003

(30) Foreign Application Priority Data
Apr. 25, 2003 (TW) 092206641

(51) Int. Cl. H01R 13/24

(52) U.S. Cl. 439/824

(57) ABSTRACT

The present invention provides a connecting terminal for electrode contact. The terminal is configured to a circuit board for contacting electrodes of an external battery. The terminal comprises: a body having a container, wherein a first opening and a second opening passing through the container are respectively disposed in two ends of the body, the first opening circularly has an obstruction; a contacting portion disposed in an end of the container of the body and exposed out of the first opening, wherein a stopper is circularly disposed in an end of the contacting portion; a dowel configured to the second opening of the body; an elastic member limited in between the contacting portion and the dowel. Whereby, the present invention facilitates manufacture and fabrication of the terminal, strengthens the construction of the terminal, and lengthens the life-span of the terminal.

### FIELD OF THE INVENTION

The present invention is related to a connecting terminal for electrode contact. More particularly, the present invention facilitates manufacture and fabrication of the terminal, strengthens the construction of the terminal, and lengthens the life-span of the terminal.

### BACKGROUND OF THE INVENTION

The conventional terminal structure (as shown in FIG. 4) is composed of a bushing 50 and a contacting portion 51. A spring 52 is disposed between the bushing and the contacting portion. A closing side 502 and an opening 501 are respectively disposed in two ends of the bushing 50 for mounting the closing side 502 on the circuit board for contacting electrodes of an external battery. While fabricating, the spring 52 first inserts the opening 501 in an end of the bushing 50, and then puts into the contacting portion 51. Thus, the contacting portion 51 is configured to the bushing 50 and the opening 501 in an end of the bushing 50 is riveted tight together by some tools (clips), forming the terminal structure.

Although the above terminal structure is capable of mounting on a circuit board for contacting electrodes of the external battery, since the volume of the terminal structure is small and it needs some tools (or clips) to rivet the opening 501 in an end of the bushing 50 tight together, it is hard to control the force when using tools. It is possible to damage or distort the terminal by using tools when manufacturing or fabricating. Therefore, yield rate of the terminal may reduce during manufacturing or fabricating. On the other hand, since the tools (or clips) only rivet tight the opening 501 on the end of the bushing, under chronic reciprocating operation for the contacting portion 51, the riveted opening 501 may breach after a period of time, which will cause the terminal unable to contact the electrode of the external battery. Therefore, the above-mentioned terminal structure can not meet realistic needs.

### SUMMARY OF THE INVENTION

The main objective of the present invention is to provide a connecting terminal which facilitates manufacture and fabrication.

Another objective of the present invention is to strengthen the construction of the terminal and lengthen the life-span of the terminal.

To achieve the above objectives, the present invention provides a connecting terminal for electrode contact. The terminal is configured to a circuit board for contacting an electrode of an external battery.

The terminal comprises:

a body having a container, wherein a first opening and a second opening passing through the container are respectively disposed in two ends of the body, the first opening circularly has an obstruction for gradually narrowing an end of the body;

a contacting portion disposed in an end of the container of the body and exposed out of the first opening, wherein a stopper, responsive to the inner side of the obstruction, is circularly disposed in an end of the contacting portion;

a dowel configured to the second opening of the body;

an elastic member, disposed in the container of the body, limited in between the contacting portion and the dowel, wherein one end of the elastic member withstands an end of the contacting portion and the other end withstands an end of the dowel.

Whereby, the present invention facilitates manufacture and fabrication of the terminal, strengthens the construction of the terminal, and lengthens the life-span of the terminal.

### BRIEF DESCRIPTION OF THE DRAWINGS

The present invention will be better understood from the following detailed description of preferred embodiments of the invention, taken in conjunction with the accompanying drawing, in which:

FIG. 1 is a view showing the outward appearance of the present invention;

FIG. 2 is a view showing a separation view of the present invention;

FIG. 3 is a view showing a cross-section view of the present invention; and

FIG. 4 is a cross-section view in an electroplating configuration of the present invention.

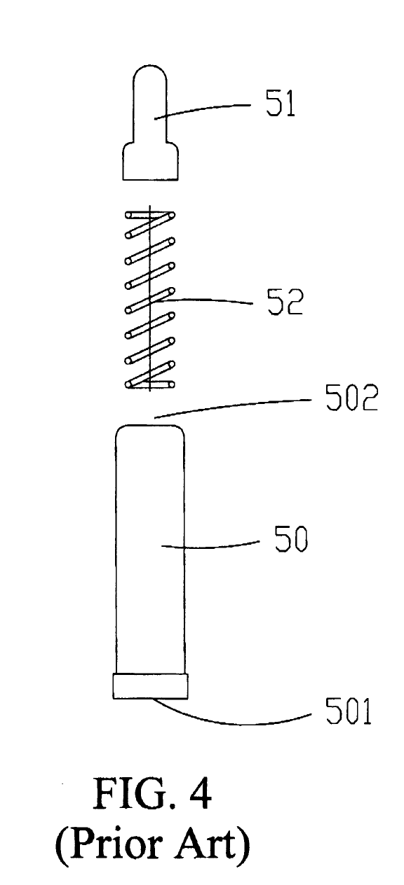

### DETAIL DESCRIPTION OF THE INVENTION

The following descriptions of the preferred embodiments are provided to understand the features and the structures of the present invention.

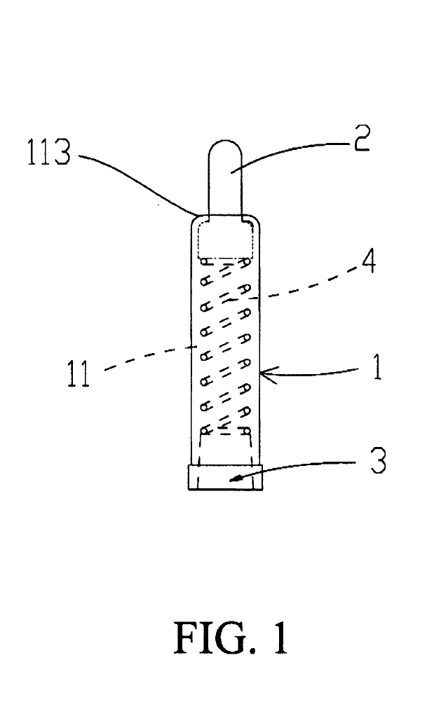

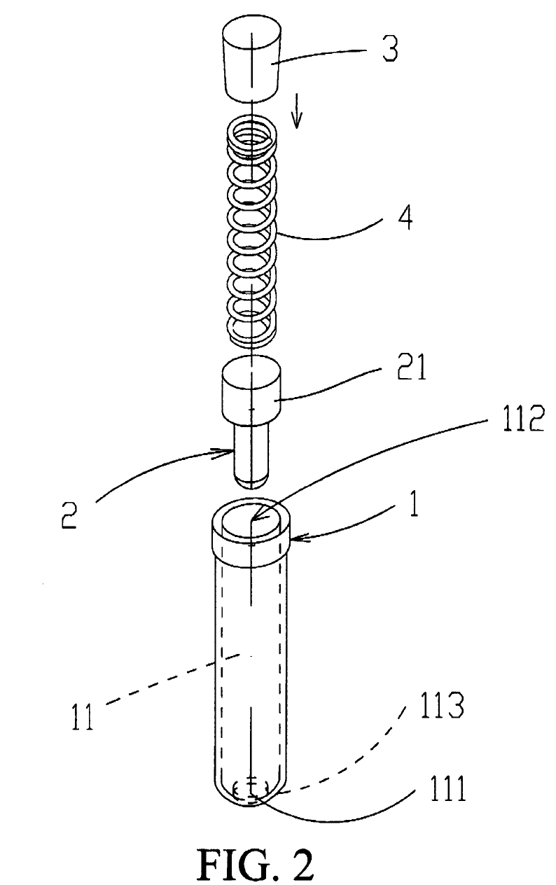

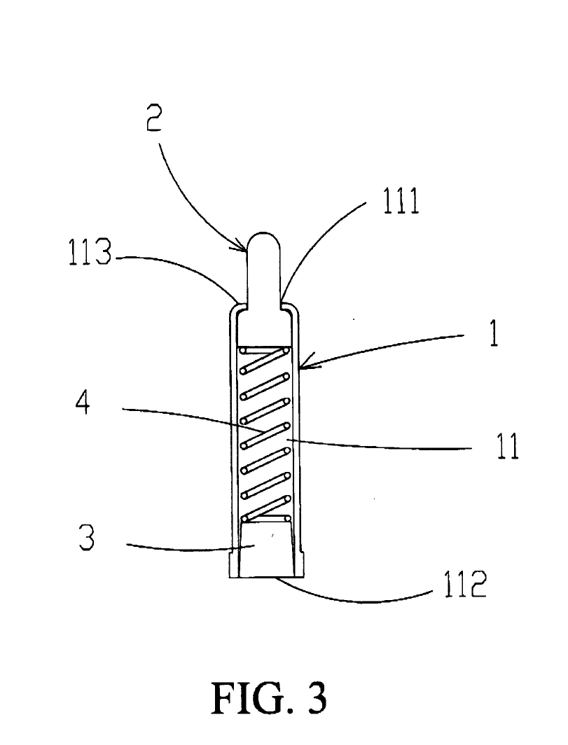

FIG. 1, FIG. 2 and FIG. 3 are respectively a view showing the outward appearance of the present invention, a separation view of the present invention, and a cross-section view of the present invention. As shown in the drawings, the terminal is configured to a circuit board for contacting electrodes of an external battery (not shown), which is composed of a body 1, a contacting portion 2, a dowel 3, and an elastic member 4. The present invention facilitates manufacture and fabrication of the terminal, strengthens the construction of the terminal, and lengthens the life-span of the terminal.

The body 1 has a container 11. A first opening 111 and a second opening 112 passing through the container 11 are respectively disposed in two ends of the body 1. The first opening 111 circularly has an obstruction 113 for gradually narrowing an end of the body 1.

The contacting portion 2 is disposed in an end of the container 11 of the body I and is exposed out of the first opening 111. A stopper 21, responsive to the inner side of the obstruction 113, is circularly disposed in an end of the contacting portion 2. Thus, the contacting portion 2 is limited in the first opening 111 of the container 11.

The dowel 3 is configured to the second opening 112 of the body 1. An end of the dowel is narrower for entering the second opening 112.

The elastic member 4 is disposed in the container 11 of the body 1 and is limited in between the contacting portion 2 and the dowel 3. One end of the elastic member 4 withstands an end of the contacting portion 2 and the other end withstands an end of the dowel 3. Thus, the contacting portion 2 can chronically reciprocate by means of the elastic member 4. Also, by the limitation of the stopper 21 of the contacting portion 2 and the obstruction 113 in the first opening 111 of the body 1, the contacting portion 2 will not leave from the first opening 111 of the body 1. Thus, a novel contacting terminal for electrode contact is provided.

While fabricating, the contacting portion 2 inserts the second opening 112 of the container 11 of the body 1. The contacting portion 2 is limited by inner side of the obstruction 113 via the stopper 21, which is then put into the elastic member 4. The contacting portion 2 is limited and is exposed out of the first opening 111 of the container 11. One end of the elastic member 4 withstands an end of the contacting portion 2. Finally, the dowel 3 is put into the second opening 112 of the container 11 of the body 1. The narrow end of the dowel 3 inserts into the second opening 112 and the wide end of the dowel 3 is clogged in the second opening 112 of the container 11 of the body 1. The other end of the elastic member 4 withstands the end of the dowel 3. Whereby, the present invention facilitates manufacture and fabrication of the terminal, strengthens the construction of the terminal, and lengthens the life-span of the terminal.

From the above detail description, persons skilled in the art should understand that the present invention truly can achieve the above objective, which is patentable.

1. A connecting terminal for electrode contact, wherein said terminal is configured to a circuit board for contacting an electrode of an external battery, said terminal comprising:
a body having a container, wherein a first opening and a second opening passing through said container are respectively disposed in two ends of said body, said first opening circularly has a obstruction for gradually narrowing an end of said body;
a contacting portion disposed in an end of said container of said body and exposed out of said first opening, wherein a stopper, responsive to the inner side of said obstruction, is circularly disposed in an end of said contacting portion;
a dowel configured to said second opening of said body;
an elastic member, disposed in said container of said body, limited in between said contacting portion and said dowel, wherein one end of said elastic member withstands an end of said contacting portion and the other end withstands an end of said dowel; wherein said connecting terminal facilitates manufacture and fabrication, strengthens the construction of said terminal, and lengthens the life-span of said terminal.
